(19) United States
(12) Patent Application Publication
(10) Pub. No.: US 2010/0287398 A1
(43) Pub. Date: Nov. 11, 2010

(54) VEHICLE CONTROL UNIT HAVING A MICROCONTROLLER THE SUPPLY VOLTAGE OF WHICH IS MONITORED AND ASSOCIATED METHOD

(75) Inventors: Alexander Froschhammer, Regensburg (DE); Marco Kick, Kernen (DE); Rainer Lenhart, Regensburg (DE); Gerhard Prochazka, Wien (AT); Bernhard Schinkowitsch, Sierndorf/March (AT)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/679,701

(22) PCT Filed: Sep. 1, 2008
(86) PCT No.: PCT/EP08/61475

§ 371 Date: Jun. 18, 2010

(30) Foreign Application Priority Data
Sep. 24, 2007 (DE) 10 2007 045 509.9

(51) Int. Cl. G06F 1/28

(52) U.S. Cl. 713/340

(57) ABSTRACT

A vehicle control unit has a microcontroller, to which multiple analog supply voltages are applied, and a monitoring unit for the functional monitoring of the microcontroller. The microcontroller includes an A/D converter for the conversion of the plurality of analog supply voltages into digitized supply voltages. A computing area of the microcontroller which is computationally secured is provided for monitoring the digitized supply voltages of the microcontroller. The plurality of digitized supply voltages are monitored in the area as to whether they lie within predetermined tolerance ranges.

The invention relates to a vehicle control unit comprising a microcontroller to which a plurality of analog supply voltages are applied and a monitoring unit for function monitoring of the microcontroller.

Modern microcontrollers (μCs) used in electronic vehicle control devices, e.g. engine control devices, transmission control devices, check units in the chassis region of motor vehicles, etc., are supplied in each case with a plurality of supply voltages simultaneously, e.g. 1.5 V and 3.3 V. Error-free and correct operation and functioning of the relevant microcontroller, in particular the applications and computational procedures running thereon, are ensured if these supply voltages are largely stable, i.e. remain within associated defined tolerance bands. This is continuously verified by means of voltage monitoring. Specific hardware voltage monitoring devices have typically been used in the past for voltage monitoring. In practice, these are referred to as so-called “watchdogs”. Such hardware monitoring devices are relatively expensive if they are to function with sufficient precision or accuracy. Moreover, due to the hardware implementation of such a voltage monitoring device, its parameterization and flexibility are often excessively limited or restricted in practice.

The object of the invention is to provide a vehicle control unit comprising a microcontroller whose plurality of analog supply voltages can be monitored more easily than is possible using specifically assigned and purely hardware-based “watchdogs”, while simultaneously offering sufficient functional reliability. In the context of a vehicle control unit of the type cited in the introduction, this object is achieved in that the microcontroller comprises an A/D converter for converting its plurality of analog supply voltages into digitized supply voltages and in that, for the purpose of monitoring of these digitized supply voltages of the microcontroller, provision is made for a computationally validated computing region in the microcontroller, where the plurality of digitized supply voltages are monitored to establish whether they lie within predetermined tolerance ranges.

As a result of monitoring the plurality of analog/digital converted supply voltages of the microcontroller by means of one or more threshold comparison operations or threshold comparison procedures in a computationally validated region of the microcontroller, in order to establish whether they lie within predetermined specific tolerance ranges, it is possible to check or “monitor” specific desired voltage values individually (i.e. specifically) for the plurality of supply voltages without the need for hardware monitoring units, yet with sufficient monitoring reliability. Despite the absence of dedicated hardware monitor units for voltage monitoring in respect of the plurality of analog supply voltages of the microcontroller, the “software-based monitoring” of the supply voltages after their A/D conversion, i.e. digitization, provides dependable information about the actual stability or robustness of the analog supply voltages of the microcontroller. In particular, the monitoring of the digitized supply voltages in a computationally validated region of the microcontroller contributes to ensuring that analysis errors relating to the digitized measured supply voltages are largely avoided. This diagnostic reliability is particularly advantageous in the case of vehicle control units such as e.g. engine control units, transmission control units or other reliability-related control devices such as e.g. in the region of the chassis, where high availability is required, i.e. failure during running mode is unacceptable or not permissible. In comparison with pure hardware “watchdog” solutions, this “software-based monitoring” of the digitized supply voltages in a validated computing region of the microcontroller allows greater flexibility, e.g. with regard to prescribed tolerance ranges or tolerance bands for the supply voltages to be monitored, such that a suitable balance can be ensured as far as possible between reliability of monitoring and availability of the overall system of the vehicle control unit.

The invention also relates to a method for monitoring a plurality of analog supply voltages which are applied to the microcontroller of a vehicle control unit, wherein the functioning of said microcontroller is monitored with the aid of an assigned monitoring unit, which method is characterized in that the plurality of analog supply voltages to be monitored are converted into digitized supply voltages by means of an A/D converter of the microcontroller, and in that these digitized supply voltages are monitored in a computationally validated computing region of the microcontroller to establish whether they lie within predetermined tolerance ranges.

Other developments of the invention are described in the subclaims.

The invention and its advantageous developments are explained in greater detail below with reference to drawings, in which:

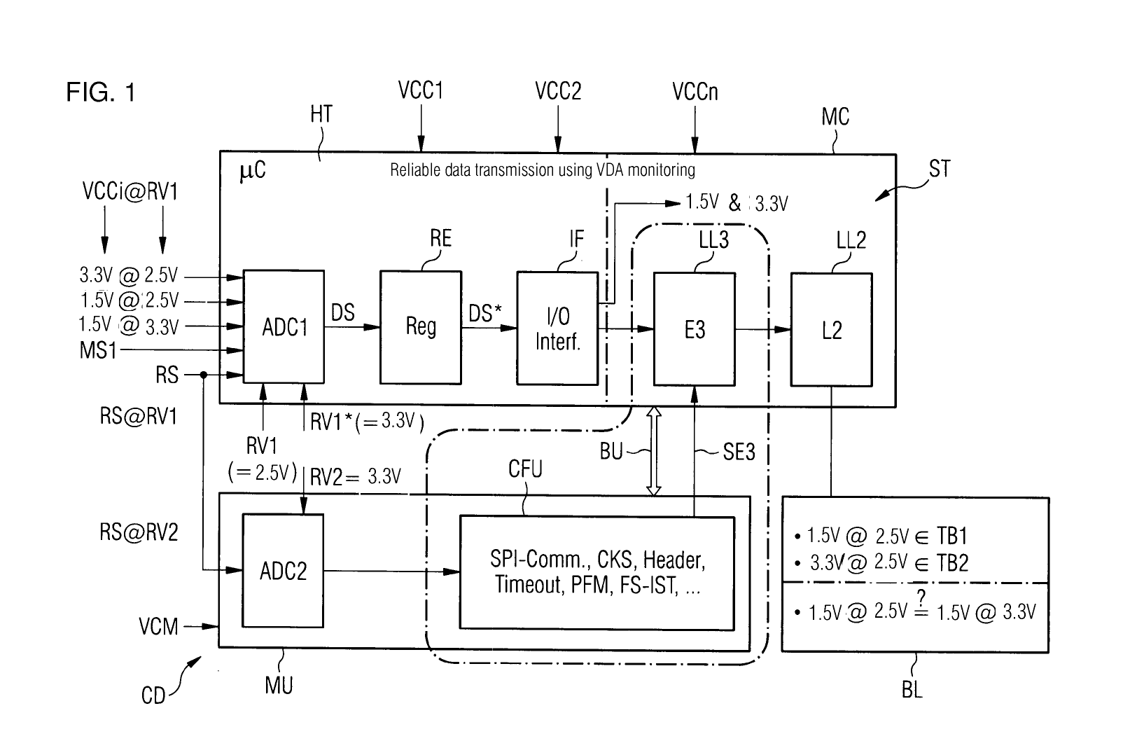

FIG. 1 shows a schematic representation of an exemplary embodiment of a vehicle control unit according to the invention, and

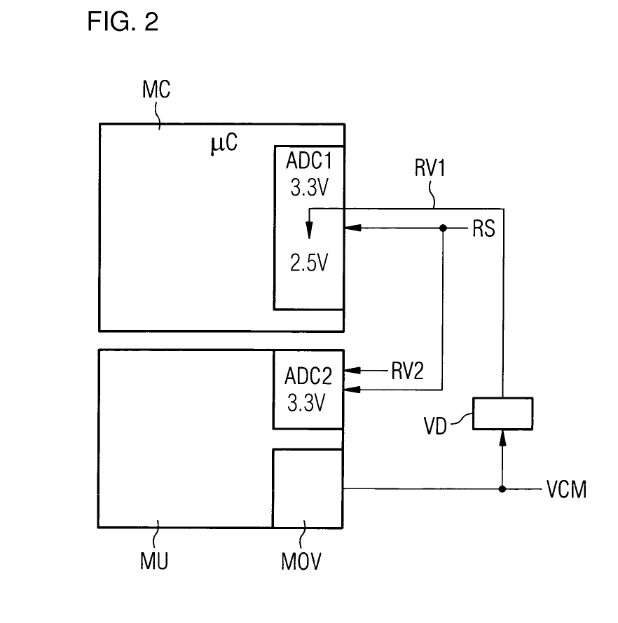

FIG. 2 shows a schematic representation, as a detail of the control unit from FIG. 1, of the voltage-related interconnexion between its microcontroller and an assigned hardware monitoring unit.

Elements having an identical function and operation are denoted in each case by the same reference signs in FIGS. 1 and 2.

FIG. 1 shows a schematic representation of the structure and functioning of an exemplary vehicle control unit CD comprising a microcontroller MC, whose plurality of analog supply voltages VCC1 to VCCn are “monitored” for stability in accordance with the inventive monitoring concept, i.e. they are verified for compliance with specifically predetermined voltage values within acceptable, i.e. predefined tolerance bands. In particular, the vehicle control unit consists of an engine control device for an internal combustion engine. The microcontroller MC is linked to an individual hardware monitoring unit MU via a bus system BU for the purpose of function checking. The microcontroller MC has an analog/digital (A/D) converter ADC1 on the input side. This is used to transform or convert into associated digital values DS the profile of the levels of at least one analog measurement signal MS1 that is to be analyzed. The measurement signal MS1 is preferably generated by at least one vehicle component, e.g. the gas pedal of a motor vehicle, and supplied to the analog/digital converter ADC1 of the microcontroller MC. From the analog/digital converter ADC1, the generated digital values DS are output to a subsequent register RE for intermediate storage. From the register or intermediate store RE, the digital values that are buffered there are forwarded to an input/output interface (I/O interface) IF. These are designated by DS* in FIG. 1. The I/O interface serves as an interface between the peripheral components and the function computer ST of the microcontroller MC, where its operating and processing software is implemented. The function computer ST has a so-called L3 level or L3 layer LL3 for the purpose of computer monitoring. In this case, computer monitoring is understood to mean the correct interaction of software and hardware structures of the microcontroller MC, whose topology allows the detection of faulty operations in the function computer (kernel, affected areas of RAM/ROM). The monitoring of the RAM/ROM storage modules generally takes place expediently in the function computer at least once per journey cycle before the engine is started (initialization or prior after-running). In particular, if a fault is detected, the engine startup is performed again in each case in the initialization. The engine startup (if software-controlled) or the combustion in the relevant cylinder of the engine preferably does not take place until the verification has been completed in the fault-free state. The L3 layer LL3 comprises two basic elements in particular. A first basic element consists of monitoring software E3 in the function computer ST. This communicates via an interface SE3 with a monitoring unit MU as a second basic element, which is physically independent from the microcontroller MC. The monitoring unit or monitoring module MU is preferably implemented as a separate hardware unit. It is used for the function monitoring of the function computer ST of the microcontroller MC. In particular, the monitoring module MU is designed as a monitoring computer. Preferably cyclically, the monitoring software E3 in the function computer ST of the microcontroller MC asks a question from a set of diverse questions, monitors the receipt of a cyclical test result which is computed by the function computer ST on the basis of the relevant transferred question, evaluates this test result and, in the event of a fault, initiates a fault response of the function computer ST. The monitoring module MU can preferably be implemented as an ASIC or a computer. The monitoring module MU operates as a so-called “watchdog” for the purpose of function checks or for monitoring the computing flows of the function computer ST. Its computing/logic unit, which carries out this monitoring of the computing functions of the function computer ST, is characterized by a block CFU in FIG. 1. Specifically, this computing/logic unit CFU provides SPI (“Serial Peripheral Interface”) communication to the L3 layer LL3 in the function computer ST and performs checksum (“CKS”) verification for the data transfer via the interface SE3, a so-called header check, a timeout check, “Program Flow Monitoring”, i.e. a check on the program flow, logic monitoring, and a function-specific instruction set test (“FS-IST”). Expressed in general terms, the logic unit CFU of the monitoring module MU therefore performs time-based and content-based monitoring of the computing processes of the function computer ST. The interaction between the independent monitoring module MU and the monitoring software E3 in the L3 level LL3 of the function computer ST is referred to as so-called question/answer communication. In particular, a plurality of test paths are serviced in the function computer in this case. Each test path delivers a precisely defined question-dependent numeric part-result. The association of the part-results produces a numeric total result (test result), which is transferred via the communication interface SE3 to the monitoring module MU. The monitoring software E3 in the function computer ST notifies the logic unit CFU in the monitoring module MU of the computationally fault-free operation by means of correct answers.

By virtue of this monitoring software E3 in the L3 layer LL3 of the function computer ST, a computationally validated computing region LL2 can be provided there. In particular, reliability-related functionalities can be calculated in this computationally validated region LL2 of the function computer ST.

The validated computing region LL2 and the computer monitoring level LL3 preferably take the form of a so-called L2 layer and L3 layer in accordance with the standardized E-Gas monitoring concept of Otto and diesel engines.

In order that the plurality of analog supply voltages VCC1 to VCCn of the microcontroller MC can now be monitored without further hardware monitoring modules or “watchdogs” (i.e. using only the monitoring unit MU which is present in any case and is used for the computational function check of the function computer ST) in terms of stability relative to assigned prescribed voltage values, the analog supply voltages VCC1 to VCCn are applied to the at least one input port of the analog/digital converter ADC1 of the microcontroller MC and converted into digital supply voltages. The digitized supply voltages are then analyzed in the validated computing region LL2 of the function computer ST and monitored to establish whether they correspond to predetermined digital voltage values within predefined tolerance bands. As a result of the plurality of analog/digital converted supply voltages of the microcontroller being monitored in a computationally validated region of the function computer of the microcontroller, by means of one or more threshold comparison procedures, as to whether they comply with desired digital voltage values without unacceptable deviation, it becomes individually (i.e. specifically) possible to check or monitor the plurality of analog supply voltages with sufficient diagnostic reliability and without the need for additional hardware monitoring units. Despite the lack of dedicated hardware monitor units for voltage monitoring of the plurality of analog supply voltages of the microcontroller, the software-based monitoring of the supply voltages after A/D conversion (i.e. digitization) provides reliable information about the extent of the stability or robustness of the compliance of the analog supply voltages of the microcontroller. In particular, the monitoring of these digitized supply voltages in the computationally validated region LL2 of the function computer ST helps to ensure that analysis errors relating to the digitized measured supply voltages are largely avoided. This diagnostic reliability is advantageous in particular in the case of vehicle control units such as e.g. engine control units, transmission control units or other reliability-related control devices, e.g. in the region of the chassis, where high availability is required, i.e. failure during running mode is unacceptable or not permissible. Compared with pure hardware “watchdog” solutions, this “software-based monitoring” of the digitized supply voltages in a validated computing region of the microcontroller allows greater flexibility, e.g. with regard to prescribed tolerance ranges or tolerance bands for the supply voltages to be monitored, such that a suitable balance can largely be ensured between reliability of monitoring and availability of the overall system of the vehicle control unit.

In the exemplary embodiment according to FIG. 1, three supply voltages VCCi (where i=1, 2, 3) are applied to the at least one input of the analog/digital converter ADC1 of the microcontroller MC. Specifically, these are the supply voltage VCC1=3.3 V, the supply voltage VCC2=1.5 V, and the supply voltage VCC3=1.5 V.

The analog/digital converter ADC1 of the microcontroller MC receives a reference voltage RV1, by means of which the interval between two output digital values is established. In the case of a reference voltage of e.g. 2.5 V and an 8-bit A/D converter, the interval between two consecutive digital code words is therefore 2.5 V/256=0.01 V. The reference voltage of an analog/digital converter is used to establish the step height and hence the scaling of the value range of the code words (=digital values) that can be represented. In the present exemplary embodiment, the analog/digital converter ADC1 can use both a reference voltage RV1=2.5 V and a reference voltage RV1*=3.3 V for reference. Expressed in general terms, the analog/digital converter ADC1 of the microcontroller MC can be operated using at least two different reference voltages RV1. The analog/digital conversion of the A/D converter ADC1 can therefore relate to at least two different reference voltage values. A first reference voltage value for the A/D converter ADC1 (e.g. RV1=2.5 V in this case) is preferably hardware-monitored directly or indirectly by means of a specifically assigned hardware monitor unit. In the exemplary embodiment as per FIG. 1, this hardware monitor unit takes the form of a check unit MOV which is used for voltage monitoring of the supply voltage VCM of the hardware monitoring unit MU. This detail is enlarged and schematically represented in FIG. 2. The supply voltage VCM, which is hardware-monitored by means of the specific hardware monitor unit MOV, of the monitoring unit MU provides the A/D converter ADC1 of the microcontroller with a desired first reference voltage value (RV1=2.5 V here) via at least one voltage divider VD. As a result, this first reference voltage value of the A/D converter ADC1 is also indirectly hardware-monitored with regard to voltage. It can be ensured that the reference voltage RV1 applied to the A/D converter ADC1 reliably complies with this voltage value of 2.5 V within predefined tolerance ranges. Relating to this hardware-validated reference voltage, it is then possible in the computationally validated region LL2 of the function computer ST reliably to verify whether the digital values DS, which the A/D converter ADC1 outputs relative to this validated reference voltage RV1=2.5 V for the analog supply voltages VCC1 to VCCn (e.g. VCC1=3.3 V and VCC2=1.5 V here) that are applied on the input side for stability checking, lie within predetermined tolerance ranges TB1, TB2. The combination of currently applied analog supply voltage VCCi and current reference voltage RV1 applied to the A/D converter ADC1 is symbolized by a @ character in FIG. 1. In the computationally validated layer LL2 of the function computer ST, the digital values DS of the plurality of supply voltages VCCi (e.g. VCC1, VCC2 here) are monitored to establish whether they lie within predetermined tolerance ranges (e.g. TB1, TB2 here) for the two supply voltages VCC1, VCC2 that are to be checked. In FIG. 1, this is symbolized by an ε symbol in the block BL.

If the A/D converter ADC1 is referenced using a second reference voltage value RV1*=3.3 V, this reference voltage value can be verified for stability without further hardware validation, by applying the same analog supply voltage, e.g. VCC2=1.5 V, to the A/D converter ADC1 in relation to the first reference voltage value RV1=2.5 V and the second reference voltage value RV1*=3.3 V, and cross-comparing the digital values produced thus, i.e. placing them in relation to each other, in the computationally validated region LL2 of the function computer ST. If the two digital values for the same supply voltage (e.g. VCC2=1.5 V) have the same ratio to each other, relative to the two different reference voltage values RV1=2.5 V and RV1*=3.3 V, as the two different reference voltage values RV1=2.5 V and RV1*=3.3 V, the verification in the LL2 layer of the function computer ST shows that the A/D converter ADC1 is also working correctly (i.e. accurately) for the unvalidated second reference voltage RV1*=3.3 V. A check or plausibility test in the LL2 layer therefore establishes whether the same relationship occurs between the digital values that are generated by the A/D converter ADC1 for the same applied supply voltage (here e.g. VCC2=1.5 V) in the case of the two different reference voltages RV1=2.5 V and RV1=3.3 V, as occurs between the applied reference voltages RV1=2.5 V and RV1*=3.3 V. It is therefore easily possible to test the accuracy of the second, unvalidated reference voltage RV1=3.3 V of the A/D converter ADC1 reliably by means of a comparison operation within the LL2 layer of the function computer ST. All of the voltage verifications carried out in the LL2 layer are visualized in FIG. 1 in the block BL for the present exemplary embodiment.

For the purpose of function verification of the total value range of the A/D converter ADC1 of the microcontroller MC, a further comparison operation is appropriately performed in the LL2 layer of the function computer ST. In order to achieve this, a dynamically varying reference signal RS is first applied to the input of the first A/D converter ADC1 of the microcontroller MC, which also receives its hardware-validated reference voltage RV1=2.5 V. A second analog/digital converter, which is redundant relative to the first A/D converter ADC1, then receives the same dynamically varying reference signal RS. In particular, this second analog/digital converter takes the form of the analog/digital converter ADC2 of the monitoring unit MU. This redundant A/D converter ADC2 receives an unvalidated reference voltage RV2=3.3 V. For the purpose of cross-comparison, therefore, the validated computing region LL2 of the function computer ST is supplied with digital values of the reference signal or sample signal RS from the A/D converter ADC1 of the microcontroller MC, said converter being operated using the validated reference voltage RV1, and digital values of the reference signal RS from the A/D converter ADC2 of the monitoring unit MU, said converter being operated using the unvalidated reference voltage RV2. If the digital values for one and the same reference signal or sample signal RS, said digital values being generated by the A/D converter ADC1 which is referenced using the validated reference voltage RV1 and by the second A/D converter ADC2 which is referenced using the unvalidated reference voltage RV2, have the same ratio to each other within predefinable tolerance limits as the reference voltage values RV1, RV2, then the verification in the LL2 layer of the function computer ST shows that the A/D converter ADC1 of the microcontroller MC is working correctly, not only at specific points but across its whole dynamic range. The previously specified simple cross-referencing plausibility test is therefore sufficient for this. Otherwise, a malfunction of the A/D converter ADC1 of the microcontroller MC is present.

In summary, for the purpose of monitoring the stability of a plurality of supply voltages which are applied to a microcontroller, a computationally validated function region of the function computer of the microcontroller is provided and utilized in that digital values of the analog supply voltages, said digital values being generated by means of analog/digital conversion, are verified to establish whether they lie within specifically assigned permitted tolerance bands. The following components in particular are suitable for creating this computationally validated function region in the microcontroller:
an A/D converter which is “monitored” or monitored in terms of reference voltage, for converting the analog supply voltages that are to be monitored in respect of their stability into digital values that can be processed by the flow logic in the function computer of the microcontroller; in this case, the flow logic can be implemented by software in particular;
a “monitored” (i.e. hardware-monitored) reference voltage for the A/D conversion of the A/D converter and the microcontroller, in order to prevent invalid external inputs to the A/D conversion due to an invalid reference variable;
computationally validated calculations in the function computer of the microcontroller; the computational validations can comprise in particular function-specific instruction set tests, flow monitoring, and/or cyclic RAM/ROM tests;
at least one trigger unit which allows a “reset” of the microcontroller; as a result of this, the microcontroller can be switched into a safe state and recover from faults if the analog supply voltages of the microcontroller lie outside of the specifically assigned predetermined tolerance ranges or tolerance bands (e.g. TB1, TB2) and correct operation of the microcontroller is therefore not possible.

In the computationally validated environment of the function computer ST, provision is preferably made for implementing the following flows:
read the digitized supply voltages;
perform threshold value comparisons in order to verify whether the digital value of the relevant supply voltage that is to be monitored lies within a predetermined or calculated tolerance range, within which the relevant supply voltage is considered to be largely stable at the time;
after “voltage debouncing”, corresponding fault responses are optionally triggered as applicable if a deviation from a predetermined tolerance range is detected or registered for the supply voltage that is to be monitored, i.e. if a specifically assigned upper or lower threshold value is exceeded;
if more than one supply voltage is to be monitored, it can be effective to reference the analog/digital converter of the microcontroller using various reference voltages; the detection capability of the A/D converter, i.e. its accuracy, can be increased by the resulting improved scalability of the value range of the A/D converter.

In this way, a plurality of supply voltages of the microcontroller can be monitored for stability using only a single hardware-validated reference voltage, without needing to provide a dedicated hardware monitoring unit for each supply voltage to be monitored in the microcontroller. Deviations of the analog supply voltages to be monitored can be detected by analyzing the associated digital values in a computationally validated function region of the function computer of the microcontroller, by checking the digital values to establish whether they lie within predetermined, specifically assigned tolerance ranges.

Incorrect calculations of the microcontroller, which could result in undetected faults in the threshold value comparisons for the digital values of the supply voltages to be monitored in respect of their long-term stability, are detected with the aid of the components of L3 layer LL3. ROM or RAM faults are preferably detected cyclically. “Aliveness” and periodic recurrence of the comparison functions are tested by monitoring the program flow. Instruction processing in the function computer is tested by one or more function-specific instruction set tests. For example, code copies can be used as test accounts or actual calculations can be performed at assembler level. Faults in the provision of signals by the A/D converter can be detected by monitoring the A/D converter.

This monitoring concept for a plurality of supply voltages of a microcontroller has the following advantages in particular:
It can be incorporated into existing monitoring concepts, e.g. into the standardized E-Gas monitoring concept for Otto and diesel engines.
Additional hardware costs resulting from specific hardware monitoring units for each monitored analog supply voltage in the microcontroller are eliminated. This reduces development work and production costs.
Despite the absence of dedicated external hardware monitor units for voltage monitoring of the plurality of analog supply voltages of the microcontroller, the “software-based monitoring” of the supply voltages after their A/D conversion in the computationally validated region of the function computer provides reliable information about the extent of the stability or robustness of the compliance of the analog supply voltages of the microcontroller. In particular, the monitoring of these digitized supply voltages in the computationally validated region of the microcontroller helps to ensure that analysis errors relating to the digitized measured supply voltages are largely avoided. This diagnostic reliability is advantageous in particular in the case of vehicle control units such as e.g. engine control units, transmission control units or other reliability-related control devices, e.g. in the region of the chassis, where high availability is required, i.e. failure during running mode is unacceptable or not permissible. Expressed in general terms, adequate overall reliability of the vehicle control unit is largely guaranteed in the context of a plurality of practical considerations.

In comparison with pure hardware “watchdog” solutions, this “software-based monitoring” of the digitized supply voltages in a validated computing region of the microcontroller allows greater flexibility, e.g. with regard to prescribed tolerance ranges or tolerance bands for the supply voltages to be monitored, such that a suitable balance can be ensured between reliability of monitoring and availability of the overall system of the vehicle control unit.
In particular, the monitoring concept explained above can be implemented within the VDA-recommended 3 level ETC monitoring concept without incurring additional hardware expense.

If the microcontroller MC comprises a plurality of analog/digital converters, all input signals to be monitored are advantageously supplied to that analog/digital converter whose reference voltage is hardware-monitored with regard to voltage. Alternatively, a cross-comparison can be made of the digital values that are output from the various analog/digital converters for one and the same sample signal, a single voltage-validated A/D converter being used as a reference. The digital values that are output by the different analog/digital converters for one and the same sample signal will have the same ratio to each other as their reference voltages if the A/D converter is functioning correctly. If not, this indicates that one of the A/D converters is not functioning or is not working correctly.

1-7. (canceled)

8. A vehicle control unit, comprising:
a microcontroller having applied thereto a plurality of analog supply voltages;
a monitoring unit connected for functionally monitoring said microcontroller;
said microcontroller having an A/D converter receiving a plurality of analog supply voltages and converting the analog supply voltages into digitized supply voltages;
said microcontroller having a computationally validated computing region for enabling a monitoring of the digitized supply voltages of said microcontroller, wherein the plurality of digitized supply voltages are monitored in said computing region as to whether or not the digitized supply voltages lie within predetermined tolerance ranges.

9. The vehicle control unit according to claim 8, wherein said validated computing region of said microcontroller is an L2 layer in accordance with a standardized E-Gas monitoring concept of Otto and diesel engines.

10. The vehicle control unit according to claim 8, which comprises a specific dedicated hardware monitor unit for voltage monitoring solely for the supply voltage of the monitoring unit.

11. The vehicle control unit according to claim 10, wherein the supply voltage of the monitoring unit, which supply voltage is hardware-monitored by way of said specific hardware monitor unit, provides a desired reference voltage to said A/D converter of said microcontroller via at least one voltage divider.

12. The vehicle control unit according to claim 8, wherein, for functionally verifying a total value range of said A/D converter of said microcontroller, said monitoring unit has a redundant A/D converter with an input receiving a same dynamically varying reference signal of a vehicle component as an input of said A/D converter of said microcontroller, and wherein said validated computing region of said microcontroller receives digital values of the reference signal from said A/D converter of said microcontroller, said A/D converter being operated using the reference voltage which is validated by hardware, and digital values of the reference signal from the A/D converter of the monitoring unit, and wherein said A/D converter is operated using the reference voltage that is unvalidated by hardware, for cross-comparing the reference voltages.

13. The vehicle control unit according to claim 8, wherein said A/D converter of said microcontroller allows a plurality of reference voltages for its operation.

14. A method for monitoring a plurality of analog supply voltages applied to a microcontroller of a vehicle control unit, the method which comprises:
monitoring a functioning of the microcontroller by way of a monitoring unit assigned thereto;
converting the plurality of analog supply voltages to be monitored into digitized supply voltages by way of an A/D converter of the microcontroller;
monitoring the digitized supply voltages within a computationally validated computing region of the microcontroller to establish whether the digitized supply voltages lie within predetermined tolerance ranges.

15. A monitoring method, which comprises:
providing a vehicle control unit with a microcontroller and a monitoring unit according to claim 8;
monitoring a functioning of the microcontroller by way of the monitoring unit;
converting the plurality of analog supply voltages received by the microcontroller into digitized supply voltages by way of an A/D converter of the microcontroller; and
monitoring the digitized supply voltages within a computationally validated computing region of the microcontroller to establish whether the digitized supply voltages lie within predetermined tolerance ranges.
